(19) United States
(12) Patent Application Publication
(10) Pub. No.: US 2020/0250244 A1
(43) Pub. Date: Aug. 6, 2020

(54) CREATING A GRAPH FROM ISOLATED AND HETEROGENEOUS DATA SOURCES

(71) Applicant: Home Box Office, Inc., New York, NY (US)

(72) Inventors: Sata Busayarat, Seattle, WA (US); Brandon C. Furtwangler, Issaquah, WA (US)

(21) Appl. No.: 16/852,981

(22) Filed: Apr. 20, 2020

Related U.S. Application Data
(63) Continuation of application No. 15/449,264, filed on Mar. 3, 2017.

(51) Int. Cl. G06F 16/951; H04L 29/08; H04L 12/24; H04N 21/431; H04N 21/858; G06F 16/27; G06F 16/71; G06F 16/901; G06F 16/958; G06F 16/957

(52) U.S. Cl. CPC G06F 16/951; H04L 67/02; H04L 67/146; H04L 67/2842; H04L 41/02; G06F 16/9574; H04N 21/8586; G06F 16/27; G06F 16/71; G06F 16/9024; G06F 16/958; H04N 21/4312

(57) ABSTRACT

The described technology is directed towards returning user interface graph nodes in a graph node format that client device platform software expects, regardless of how the underlying data is maintained, e.g., in various data sources and in various formats. When a client requests a data item (graph node) from a data service and the data service does not have a valid cached copy, the request is processed into one or more requests to backing data source(s) for the data item's dataset. The response or responses containing that data are assembled and transformed into a graph node that is returned to the client. Also described is caching data items at various requesting entity levels/request handling entity levels, batching data item requests between levels, multiplexing identical requests, and using ETags to avoid sending already existing, unchanged data between entities.

### CROSS-REFERENCE TO RELATED APPLICATION

This application is a continuation of, and claims priority to co-pending U.S. patent application Ser. No. 15/449,264, filed on Mar. 3, 2017, entitled “CREATING A GRAPH FROM ISOLATED AND HETEROGENEOUS DATA SOURCES.” The entirety of the aforementioned application is hereby incorporated herein by reference.

### BACKGROUND

Web or mobile application users interact with information via user interfaces, such as menus of data items (e.g., buttons, tiles, icons and/or text) by which a client user may make a desired selection. For example, a client user may view a scrollable menu containing data items representing video content, such as movies or television shows, and interact with the menu items to select a movie or television show for viewing.

In some scenarios including selection of movies and television shows, the underlying data that is needed for the user interface data items are not in any particular format. Moreover, the data can be scattered among numerous data sources. For example, a movie or television show's data may comprise a title, rating, a representative image, a plot summary, a list of the cast and crew, viewer reviews, and so on, at least some of which may be maintained in different data stores. Further, one data store's data may override another data store's data; e.g., the data for a particular television show episode may include a generic image URL that is usually shown, however someone (e.g., a team of the content provider's employees) may want to override the generic image with a different image, such as a more specific image for some uncharacteristic episode.

One possible solution to dealing with the different formats/data sources in which the underlying data is maintained is to have each client software platform that presents a user interface request the needed data and assemble/format it as appropriate for that client device. However, because there are typically many client software platforms for different client devices, and different software versions for each device, this is generally a complex problem. For example, for a data source that is proprietary, each client device needs at least “read” authorization to access its data. Further, relatively complex client platform software code is needed on each of the many device types; such complex client platform software code is likely unworkable on low-powered devices.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, one or more aspects of the technology described herein are directed towards receiving a request for a data item having a data type and graph node format, and determining a handler for the data type. Aspects include is using information in the handler to retrieve data for the data item from one or more backing data sources, to process the data into the graph node format and create links between nodes. The data item is returned in response to the request.

Other advantages may become apparent from the following detailed description when taken in conjunction with the drawings.

### BRIEF DESCRIPTION OF THE DRAWINGS

The technology described herein is illustrated by way of example and not limited in the accompanying figures in which like reference numerals indicate similar elements and in which:

FIG. 1 is an example block diagram representation of a client device communicating with a data service to obtain data corresponding to a graph node with which a client user may interact, according to one or more example implementations.

FIG. 2 is a representation of example data service handlers that retrieve and return client-requested data according to one or more example implementations.

FIG. 3 is a representation of an example request being forwarded through request handling entities to obtain a data item's data, according to one or more example implementations.

FIG. 4 is a representation of an example response being returned through response handling entities to return a data item's data, according to one or more example implementations.

FIG. 5 is an example representation of how client requests to a data service may be batched, with streamed responses returned, according to one or more example implementations.

FIGS. 6-9 comprise a flow diagram showing example logic/steps that may be taken by data service to return data in a graph node format including when the underlying data is maintained in various formats and/or data sources, according to one or more example implementations.

FIG. 10 is a block diagram representing an example computing environment into which aspects of the subject matter described herein may be incorporated.

### DETAILED DESCRIPTION

Various aspects of the technology described herein are generally directed towards processing various data for client interaction into graph nodes, whereby each client device only needs to deal with a user interface graph of nodes and edges.

In general, graph nodes have an identifier (ID) that is unique to the data service, and indeed may be globally unique. One or more implementations use a Uniform Resource Name (URN); (e.g., urn:hbo:menu:root) as the identifier. Graph nodes are typed; (note that in one scheme, the type of graph node also may be determined from its URN). For example, with respect to video content, there may be a graph node of type “feature” that represents some streaming video content and includes a title, a URL to an image, a rating (if known), and so forth. As another example, a graph node of type “user” may represent a client user, and may have per-user data such as a username, parental controls (such as maximum rating allowed), a “watch-list” of user-specified (and/or for example machine-learned favorite) shows of particular interest or the like, and so forth. Via the user graph node, each different client user can have a per-user customized graph portion.

In general, the underlying data for at least some of the graph nodes is not in a graph node form; instead, the data may be in any suitable format, and may be distributed among various data sources, which may comprise at least some isolated and heterogeneous data sources relative to each other. For example, a node that represents a movie data item may have a title, a rating, a representative image such as a scene from the movie or an image of the promotional movie poster, and a summary plot description. The title and rating may be in one database, the images in another data store, and the summary plot description in yet another data store. At least initially, the node subparts need to be separately requested from each appropriate source, and then reassembled into the node format. Thus, aspects of the technology described herein may be directed towards composing and processing at least some data subparts into a graph node that the client software platform understands and can incorporate into a client graph.

To this end, for each client requested data item, a data service handles the collection of the subparts of the needed data from the one or more data sources, assembles the data subparts into a node format, and returns the data item to the client as a node in a response to each request. Note that the nodes (data items) further may be customized for each client, e.g., formatted and/or shaped into a format that each different client device (e.g., the device type and the client platform software version that is in use) understands. Such data item processing is described in copending U.S. patent application Ser. No. 15/290,722 entitled “TEMPLATING DATA SERVICE RESPONSES” assigned to the assignee of the present application and hereby incorporated by reference.

At any stage of the data service's retrieval process, a cache set comprising one or more caches may be accessed to look for a copy of the data item, e.g., cached in a node format. If cached and not expired, the request may be handled at that point, whereby sub-requests to the data sources are not always needed, which is ordinarily far more efficient. If not cached, the request is sent on to a next level, such as from a front-end data service server to a back-end data service server, until (unless cached and valid at that next level) the request reaches a point where it needs to be retrieved from a backing data source. At this point, the request is separated into sub-requests as needed, with each sub-request sent to a backing data source that has that data. The type of the node/data item determines how the request is separated; e.g., a movie data item with multiple subparts/multiple backing data sources is typically handled differently from a navigation menu data item that may have its underlying data in a single backing data source.

When retrieved, the data subparts are reassembled into the appropriate node form and sent back towards the requesting client entity, with optional cache writing at each intermediate level, (as well as caching at the client device level). In this way, a data service client has no notion of how or where the underlying data is maintained, and only needs to be authenticated with the data service in order to receive a requested data item in graph node form.

In addition to accessing one or more caches to look for data items, and locating and assembling the sub-parts of the requested data item, the data service may handle batch requests for multiple data items. For example, the client may send a request for a data item as part of a batch request to the data service front end server, with the batch request separated into individual data item requests at a request handling server for seeking in a cache. Those items not cached are sent on to the back-end data service, in what may be a batch request, possibly including requests from other clients. Similarly, the back-end data service may separate a batch request from a front-end server into separate data item requests, look for each item in a back end cache, and if not found, break the data item requests into sub-requests that are batched into a batch request for each separate backing data store. Such batching is described in copending U.S. patent application Ser. No. 15/291,810 entitled “BATCHING DATA REQUESTS AND RESPONSES” assigned to the assignee of the present application and hereby incorporated by reference.

Still further, multiplexing of requests may occur at any level where requesting of data can occur. In general, multiplexing refers to combining multiple requests for the same data item or same subpart of a data item into a single request, typically within some time window/as part of a batch request to the next request receiving entity. The requesting entity is tracked in conjunction with the requested data item or subpart, so that the single response is demultiplexed into a separate response back to each requesting entity. Such multiplexing is described in copending U.S. patent application Ser. No. 15/252,166 entitled “DATA REQUEST MULTIPLEXING” assigned to the assignee of the present application and hereby incorporated by reference.

It should be understood that any of the examples herein are non-limiting. For instance, some of the examples refer to data related to client selection of video content (including audio) from a streaming service that delivers movies, television shows, documentaries and the like. However, the technology described herein is independent of any particular type of data, and is also independent of any particular user interface that presents the data as visible representations of objects or the like. Thus, any of the embodiments, aspects, concepts, structures, functionalities or examples described herein are non-limiting, and the technology may be used in various ways that provide benefits and advantages in data communication and data processing in general.

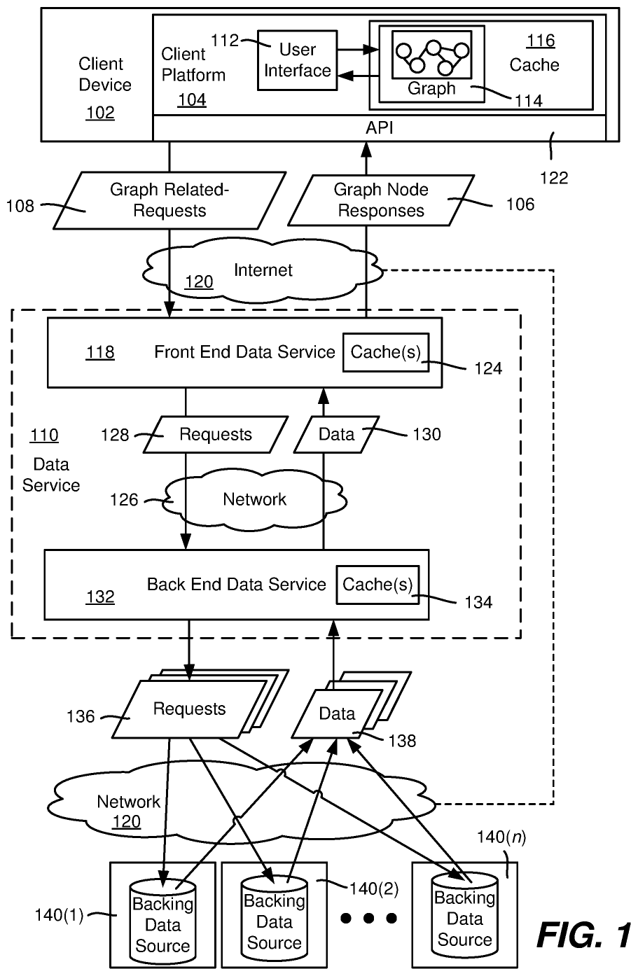

FIG. 1 is a block diagram representing example components that may be used to handle client requests for graph nodes based upon a client graph. As exemplified in FIG. 1, a client device 102 runs client platform software 104 that receives graph node responses 106 from a data service 110, based upon graph-related requests 108.

In one or more implementations, the client software program's UI elements or the like may make requests for data items to the client platform 104 (e.g., at the client's data service level) without needing to know about graph nodes or how the underlying data is maintained, organized, retrieved and so forth. For example, a tile object that represents a television show may in a straightforward manner send a request to the client platform software for a title corresponding to a title ID (which in one or more implementations is also the graph node ID), and gets the title back. As will be understood, beneath the UI level, the client platform software obtains the title from a (feature type) graph node corresponding to that ID; the graph node data may be obtained from a client cache 116, but if not cached, by requesting the graph node from the data service 110, as described herein.

As set forth above, each graph node may reference one or more other graph nodes, which forms a graph 114 (e.g., generally maintained in the client cache 116 or other suitable data storage). The client graph 114 is built by obtaining the data for these other graph nodes as needed, such as when graph nodes are rendered as visible representations of objects on the interactive user interface 112. Example visible representations of graph node data may include menus, tiles, icons, buttons, text and so forth.

In general, the client graph 114 comprises a client-relevant subset of the overall data available from the data service 110; (the available data at the data service can be considered an overall virtual graph). Because in the client platform 104 the underlying data forms the client graph 114, at least part of which is typically represented as elements on the user interface 112, a user can interact to receive data for any relationship that the data service 110 (e.g., of the streaming video service) has decided to make available, including relationships between very different kinds of data, and/or those that to some users may seem unrelated. Over time the data service 110 can add, remove or change such references as desired, e.g., to link in new relationships based upon user feedback and/or as new graph nodes and/or graph node types become available.

To obtain the graph nodes 106, the client platform 104 interfaces with the data service 110, e.g., via a client interfacing front-end data service 118, over a network such as the internet 120. An application programming interface (API) 122 may be present that may be customized for devices and/or platform software versions to allow various types of client devices and/or various software platform versions to communicate with the front-end data service 118 via a protocol that both entities understand.

The front-end data service 118 may comprise a number of load-balanced physical and/or virtual servers (not separately shown) that return the requested graph nodes 106, in a manner that is expected by the client platform software 104. As described herein, some of the requests for a graph node may correspond to multiple sub-requests that the client platform software 104 expects in a single graph node; for example, a request for a tile graph node that represents a feature (movie) may correspond to sub-requests for a title (in text), an image reference such as a URL, a rating, a plot summary and so on. A request for a user's “watch list” may correspond to sub-requests for multiple tiles. The data service 110 understands based upon each graph node's type how to obtain and assemble data sub-parts as needed, from possibly various sources, into a single graph node to respond to a client request for a graph node.

The corresponding graph node may be contained in one or more front-end caches 124, which allows like requests from multiple clients to be efficiently satisfied. For example, each load-balanced server may have an in-memory cache that contains frequently or recently requested data, and/or there may be one or more front-end caches shared by the front-end servers. The data is typically cached as a full graph node (e.g., a tile corresponding to data from multiple sub-requests), but it is feasible to cache at least some data in sub-parts that are aggregated to provide a full graph node.

Some or all of the requested data may not be cached (or may be cached but expired) in the front-end cache(s) 124. For such needed data, in one or more implementations, the front-end data service 118 is coupled (e.g., via a network 126, which may comprise an intranet and/or the internet) to make requests 128 for data 130 to a back-end data service 132.

The back-end data service 132 similarly may comprise a number of load-balanced physical and/or virtual servers (not separately shown) that return the requested data, in a manner that is expected by the front-end data service 118. The requested data may be contained in one or more back-end data caches 134. For example, each load-balanced back-end server may have an in-memory cache that contains the requested data, and/or there may be one or more back-end caches shared by the back-end servers.

For requests that reach the back-end data service 132 but cannot be satisfied from any back-end cache 134, the back-end data service 132 is further coupled (e.g., via an intranet and/or the internet 120) to send requests 136 for data 138 to one or more various backing data sources 140(1)-140(n). Non-limiting examples of such data sources 140(1)-140(n) may include key-value stores, relational databases, file servers, and so on that may maintain the data in virtually any suitable format. A client request for graph node data may correspond to multiple sub-requests, and these may be to backing data sources; the data service 110 is configured to make requests for data in appropriate formats as needed to the different backing data sources 140(1)-140(n). Moreover, one data store's data may override another data store's data; e.g., the data for a television show may include a generic image URL obtained from one data store, however an “editorial”-like data store may override the generic image with a different image, such as for some uncharacteristic episode. Note that in one or more implementations, non-cache data sources 140(1)-140(n) may use a wrapper that implements a common cache interface, whereby each remote data source 140(1)-140(n) may be treated like another cache from the perspective of the back-end data service 132.

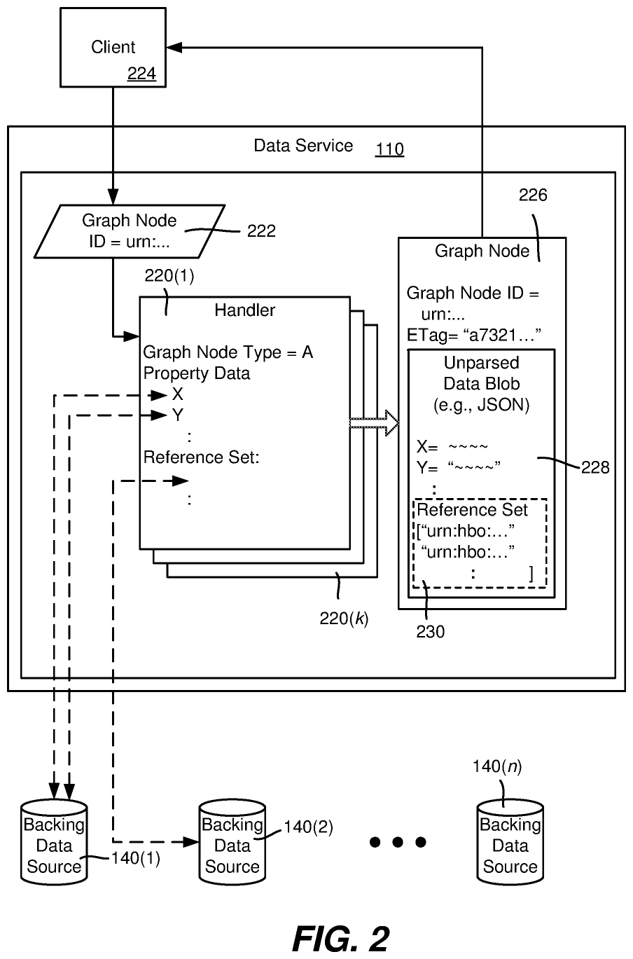

FIG. 2 shows handlers 220(1)-220(k) of the data service 110 that obtain the data for each handler's respective graph node type, e.g., based upon the graph node ID, from one or more of the backing data sources 140(1)-140(n). In general, a handler is selected based upon the URN (although a “type ID” may be used in alternative implementations); each handler knows the needed parts of its graph node type and which backing data source maintains each part. For example, the handler that returns a feature-type graph node when given a graph node ID may obtain the title from one backing data source, the rating (if any) from (possibly) another backing data source, a URL to an image that represents the feature from (possibly) another backing data source, the reference set of one or more references to other graph node(s) from (possibly) another backing data source, and so on. At least some of these data may be overridden by data from another data source.

Thus, given a graph node ID, the type is determined, and the handler for that type selected. The data service via the handler's information (which may include handler logic run as part of the data service) obtains the needed data, and returns the data in an unparsed form, e.g., as a JavaScript® Object Notation, or JSON data blob, along with an ETag (entity tag) value and an expiration value (TTL, typically a date/timestamp) in one or more implementations. In FIG. 2 this is exemplified as the handler 220(1) handling a graph node request 222 for a specific graph node ID from a client 224 by obtaining property data from the backing data source 140(1) and the reference set from backing data source 140(2), and returning a graph node 226 including the graph node data body 228 with the property data and the completed reference set 230 to the requesting client 224. In one or more implementations, the graph node knows how to parse its unparsed data into an object format.

Note that in general, the use of the reference set creates links to other nodes and thereby forms a graph structure of nodes. One way in which the information to include in the reference set may be determined is generally similar to how a graph node's properties are determined. A difference is that a reference such as a URN (or multiple URNs) goes into the reference set to create the link or links, in which each URN is an identifier of another graph node. Note that nothing need be known regarding the content of the referenced target node on the other end of the link; (for example, the content may be stored in a different data source). The only information generally needed is that that referenced node exists and what its URN is (and possibly a relationship).

Further note that at least some graph edges contain a “label” or the like to identify a relationship. For example, an Episode node may have one link to its parent node, Season, and another to its grandparent node, Series. Those links may be labeled “season” and “series” respectively. In general, this “stitches” together multiple nodes from possibly multiple sources to create one connected graph.

As is understood, the handler-based retrieval mechanism allows for straightforward changes to be made. For example, if data is moved among the sources or a new data source added, the appropriate-type handler(s) are updated. For example, if the title and rating were in separate data sources but now are stored together in a single data source, the feature-type handler may be updated to get these items together in a single request. A handler also knows which data source or sources override which other data source or sources.

Once the data for a data item (graph node) is obtained, the data item may be cached via a key that represents its ID, and accessed from the cache thereafter, until it expires. Any data item can also have an ETag comprising a hash value or the like that represents the data of that node computed for that node and included as part of its header meta-information. If a desired item is cached but has expired, the request for the item may include the ETag, e.g., with an If-None-Match: <ETag> header, to see if the resource's has changed. If the ETag matches, then no change to the data has occurred and a suitable response (e.g., with a status code of ‘304’) is returned to indicate this unchanged state, without the resource's data, to save bandwidth. In one or more implementations a new expiration time is returned (or obtained in some other way, such as a default value per type) so that when the data item is cached, future requests for that data item need not repeat the ETag sending process, until the key is again expired.

If no ETag matches then the resource data is returned with a status code of 200 as normal. The data item is cached with a new ETag and TTL expiration value at any caching level, and returned to the client 224.

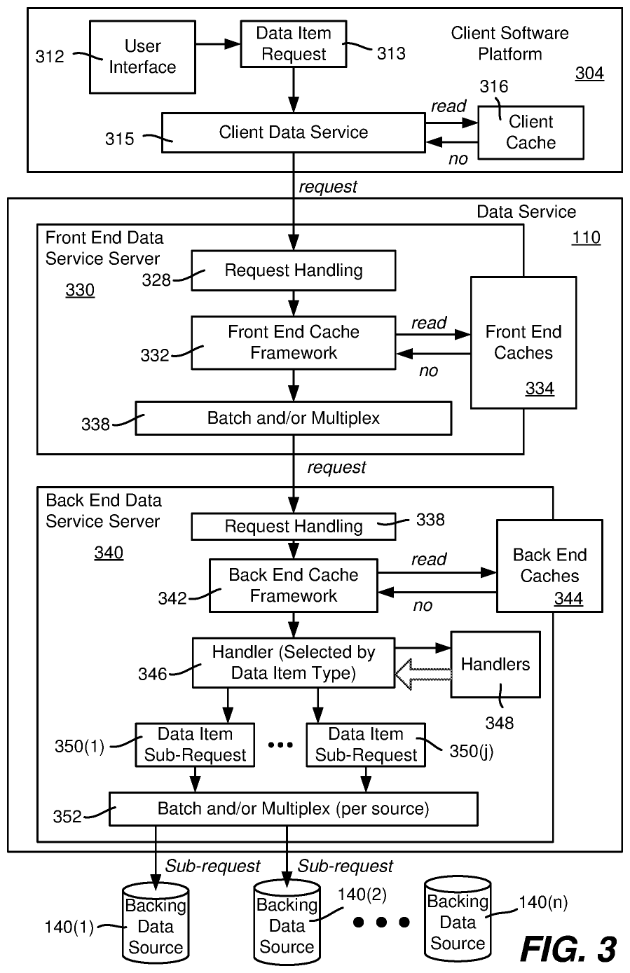

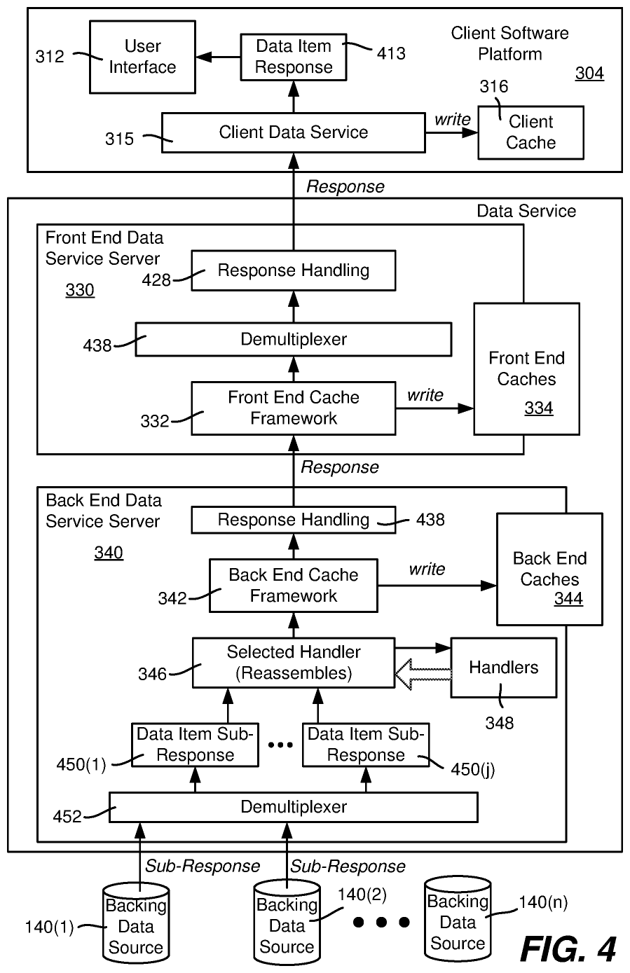

FIG. 3 is a block diagram representing an example request for a data item, with FIG. 4 representing an example response. In FIG. 3, a user interface 312 makes a data item request 313 to a client data service 315 of client platform software 304. As is typical, the client data service 315 first looks to a client cache 316 for the data item. If found, the data item is returned in response to the request.

In this example, consider that the requested data item is not found in the cache 316, or is found and expired, whereby the client data service 315 sends the request to a request handling component 328 of a front end data service server 320, such as a server selected via a load balancer of the data service 110; (the request may include an ETag if the data item was cached but expired). The requested data item may be a request that is part of a batch request, in which the request handling component 328 separates the batch request into its individual data item requests, and tracks which data items are associated with each batch request. This allows returning the correct set of data items to the correct requesting client, as multiple clients are typically making requests to the same server. Note that individual data items are cached rather than batched sets of data items, because a very low hit rate is likely to occur for a request seeking multiple data items.

In general, the request for each data item is processed by first providing the request to a front-end cache framework that manages a set of one or more front-end caches 334. For example, there may be an in-memory cache on each server, including the server 330 of FIG. 3, as well as a cache that is shared by multiple front end servers, and possibly even another cache. The cache framework 332 searches each cache in the cache set 334 in order (e.g., in-memory first, then shared, and then any other). If the data item is found and valid in a cache, then that item is returned, (which may be after being held for returning in a batch response with other requested data items). The cache framework also writes data item to any caches that did not contain a valid copy of data item.

In this example, consider that at least one data item is not found valid in a front-end cache, whereby the request is sent to a back end data service, e.g., load balanced to a back end data service server 340. However, before the data item request is sent, the data item request may be batched and/or multiplexed (block 338) as generally described above. Note that multiple client devices may be making generally concurrent requests for data items to the server 330, and thus for efficiency any requests that reach the point at which they need to be obtained from the back end data service may be combined in a batch request; (it is also feasible for the same client device to request more than one instance of the same data item at generally the same time, e.g., in two different batch requests, although this is generally unlikely and is also able to be handled by multiplexing client device requests for the same data item).

In any event, multiple requests to the back end data service may be batched together. Further, multiple instances of the same data item request may be multiplexed together, e.g., by only sending one request for a data item within the batch request and tracking each entity that wanted that data item once received.

Thus, the back-end data service server 340 receives a request for the data item (which may be part of a batched and/or multiplexed request) at a back end request handling component 338. For each requested data item, the back end service similarly has a back end cache framework 342 that looks for that data item in its back end cache set 344 (e.g., a server in-memory cache and a cache shared with other back end servers).

If not found in any cache, or found but expired, then a handler 346 for that data item's type is selected from among a set of handlers 348. As described above, the handler contains the details (e.g., data subparts needed, subparts-to-data source mappings, any needed credentials to the data sources, any data reformatting requirements, any possible overriding data sources and so on) that are needed to retrieve the dataset (as a whole or in subparts that are assembled into the dataset) for the requested data item. Thus, in the example of FIG. 3, the handler separates the data item request into sub-requests 350(1)-350 (j) for its subparts sent to one or more of the backing data sources 140(1)-140(n); note that for some data items, the data item's data is not separated into subparts; further, two or more subparts may be in the same data blob maintained at a data source, in which event the handler may filter out unneeded parts/retain only the subparts needed. As used herein, there may be only one subpart that contains a given data item's data in its entirety.

Still further, one backing data source may contain two or more subparts of data for a data item, in which two or more separate requests need to be made to the same backing data source to obtain each subpart. For example, a movie data store may need one query to return the release year (e.g., if a remake was made) and another query based upon the release year to return the cast and crew data for that movie-related node.

As set forth above, any request to a data-providing entity may be batched and/or multiplexed before sending to that entity. Thus, as represented in FIG. 3 by block 352, any request made to any backing data source may be batched and/or multiplexed with other requests to that same backing data source on a per source basis.

FIG. 4 shows the return path for a response 413 containing the example data item request 313 of FIG. 3. In general, if multiplexing was used at the subpart level, a demultiplexer 452 returns the data item sub-responses to each appropriate requesting entity, e.g., a single sub-part response may be sent back to multiple senders, which in this event are the handler instances that divided data item requests. The handler reassembles/otherwise processes the sub-responses 450(1)-450(j) into the appropriate data item, which at this time may be in a generalized node format.

The reassembled data item is then provided to the back-end cache framework 342 for writing to the back end caches 344. Response handling logic 438 returns the data item to the front end data server that made the request, e.g., by tracking which data item requests came from which font end server.

Note however that a batch response is ordinarily not returned to a front-end server batch request in one or more implementations. This is to prevent any data item, or any data item sub-part, from delaying a response to a request. For example, consider that one client1 has requested data items [A, B and C] in a batch request, while another client2 has requested data items [B, C and D] in a batch request. If a batched, multiplexed request of data items [A, B, C and D] is made to the back end server, and data items [B, C and D] are cached in back end cache, these data items can be quickly returned individually to the front end server. Data item A, however, has to be obtained from one or more backing data sources.

Continuing with the example of client1 and client2, at the front end, data items [B, C and D] are available as soon as ready, and thus returned relatively quickly in a response to the client2, satisfying client2's request. This response may occur long before data item A is returned to the front end server (for returning along with data items B and C to client1). Thus, instead of making client 2 wait for client1's needed data because of batching and multiplexing, by not batching the back end server's response to the front end server's batch request, requests can be responded to each client separately as soon as each part is ready.

Returning to FIG. 4, when returned to the front end server 330, the requested data item is cached at the front end cache or caches 334. Further, the data item may be a response to what was multiplexed, batched request. If so, a demultiplexer 438 makes a copy for each requesting entity that has made a request for that data item. Response handling logic 428 formats a suitable response to the client data service 315, for caching at the client, and for use in the user interface 312.

Note that in one or more implementations, the response handling logic 428 returns a batch response to a client batch request by tracking which data items need to go in which client's batch response and sending the batch response when all requested items are available from whatever source contained each item (e.g., front-end cache, back-end cache, backing data source, and so on). This simplifies the client code. However, it is alternatively feasible to return individual or partial batch responses to a requesting client, which may be beneficial if a client device is likewise performing batching and multiplexing operations.

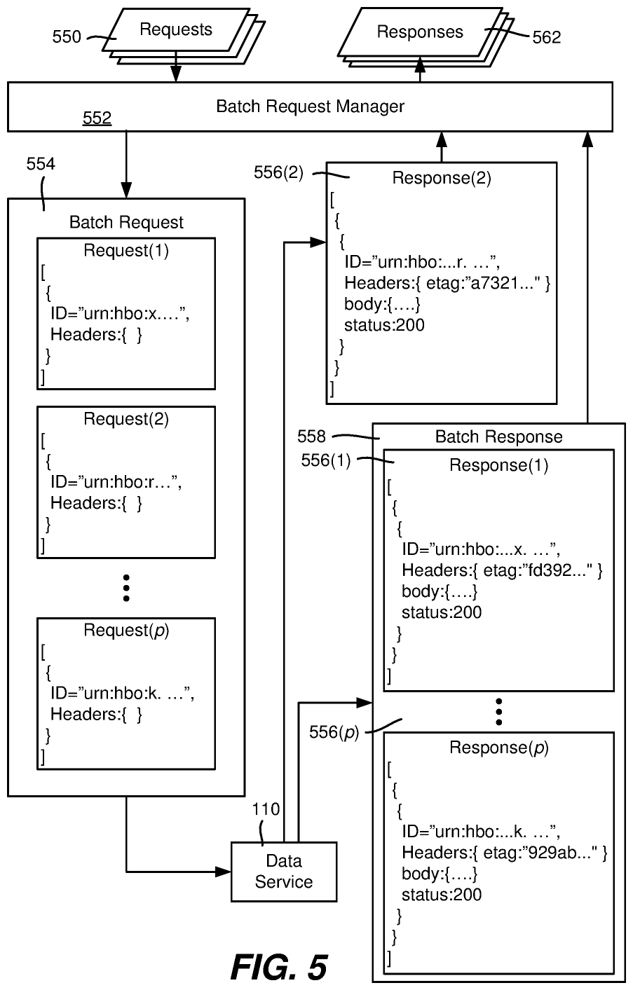

To summarize batching as described herein by way of an example as represented in FIG. 5, any requesting entity's requests 550 may be independently seeking pieces of data generally at the same time, and such requests may be batched by a batch request manager 552. For example, a client requestor such as a UI element may be a tile object that requests a title, rating, image URL and so forth in a one or more requests or a combined request for a single node's data. As another example, a menu object requestor may request set of tiles to present on its menu object's rendering, and each tile may correspond to a request for feature node; such a request may be batched when made and received as a batch request at the batch request manager. Thus, multiple single and/or batch requests for provider data may be made to the batch request manager 552, which the batch request manager 552 can combine into a batch request (or batch requests) for sending to the data service 110. In general, sending batch requests to the data service 110 is more efficient than sending single requests.

Moreover, the same data may be independently requested at generally the same time by different client requestors. For example, a button and a tile may seek the same provider data (e.g., an image URL) without any knowledge of the other's request. Request multiplexing at the batch manager 552 allows for combining such independent requests for the same provider into a single request for a provider to the data service 110, with the provider data from the single response returned separately (de-multiplexed) to each requestor.

In one or more implementations, the batch request manager 552 may batch up to some maximum number of requests over some defined collection time. For example, a batch request to the data service 110 may range from one request up to some maximum number of (e.g., sixteen or thirty-two) requests per timeframe, such as once per user interface rendering frame. If more than the maximum number requests are received within the timeframe, then multiple batch requests are sent, e.g., at the defined time such as once per rendering frame, although it is feasible to send a batch as soon as a batch is full regardless of the defined time. The request and response may be in the HTTP format, e.g., using a REST-like API.

As generally represented in FIG. 5, although the batch request manager 552 batches multiple requests 550 (when possible) into a single batch request 554, the requests may be processed at the data service 110 as if independently streamed. Thus, in one or more implementations, individual and/or batched responses may be streamed back by the data service 110 to the batch request manager 552, that is, as a full batch response, or in multiple sets of partial results, e.g., as soon as each individual response is ready, such as within some return timeframe. Thus in the example of FIG. 5, the response 556(2) is returned separately from the batch response 558 that contains (at least) the response 556(1) and 556(p), e.g., returned at a later time. For example, the response 556(2) may be obtained from a cache at the data service, in which event the response 556(2) may be quickly returned, whereas other responses may need to be built from the backing data sources and thus take longer to obtain and compose into provider data blobs before returning.

In one or more implementations, a response is returned for each request, and the responses may come back in any order. Expanded results also may be returned, e.g., a request for node A may result in a response that contains nodes A and B (or in two separate responses).

The results thus may be streamed, each with a status code; for a batch response, the status code indicates that an individual status code is found in the body of each response portion. Even though a response may reference one or more other node IDs in its reference set, those other nodes need not be returned in the same response. Indeed, responses are not nested (e.g., as they correspond to graph data, and are not like tree data) but rather remain independent of one another, and thus the client can independently parse each response, cache each response's data, and so on.

As can be readily appreciated, processing batched requests as individual requests having individual responses allows the data service 110 and thus the batch request manager 552 to return a provider to a requestor without waiting for another provider. Such streamed responses may be particularly beneficial when multiplexing. For example, if one client requestor is requesting provider X while another requestor is requesting providers X and Y in a batch request, the de-multiplexed response to the multiplexed request for provider X to the one client requestor need not be delayed awaiting the response for provider Y to be returned (e.g., because the data for provider Y is taking longer to obtain).

Although the requests to the data service are batched (possibly multiplexed) and may have individually or combined streamed responses, as set forth above the initial requests 550 to the batch manager 552 may include a batch request seeking a batch response. Such a batch request made by a requestor may receive a batch response from the batch request manager 552 only when each of its batched requests has a response returned. For example, a menu object that requests a number of items in a batch request may want the items returned as a batch, e.g., in the requested order, rather than have to reassemble responses to the items returned individually. In this way, for example, a menu object may request a batch of tiles and receive the tiles as a batch. The batch request manager 552 is able to assemble the data of separate providers into a batch response as described herein.

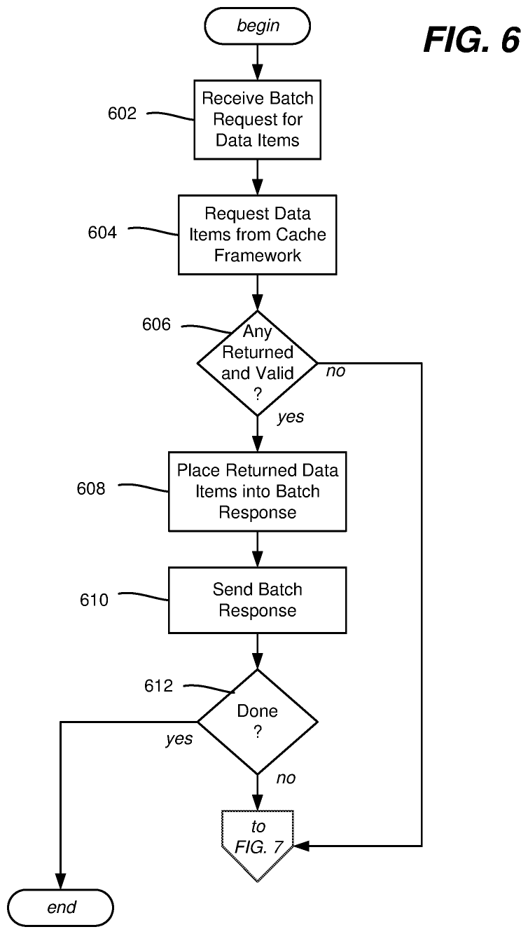

FIGS. 6-9 comprise a flow diagram showing example steps that may be taken by a back end data service to return data to a front-end data service, beginning at step 602 where a batch request for one or more data items is received. Note that a request for a single data item may be handled by the logic of FIGS. 6-10, although a simpler set of steps may be taken (e.g., without those that evaluate whether each requested item has been processed).

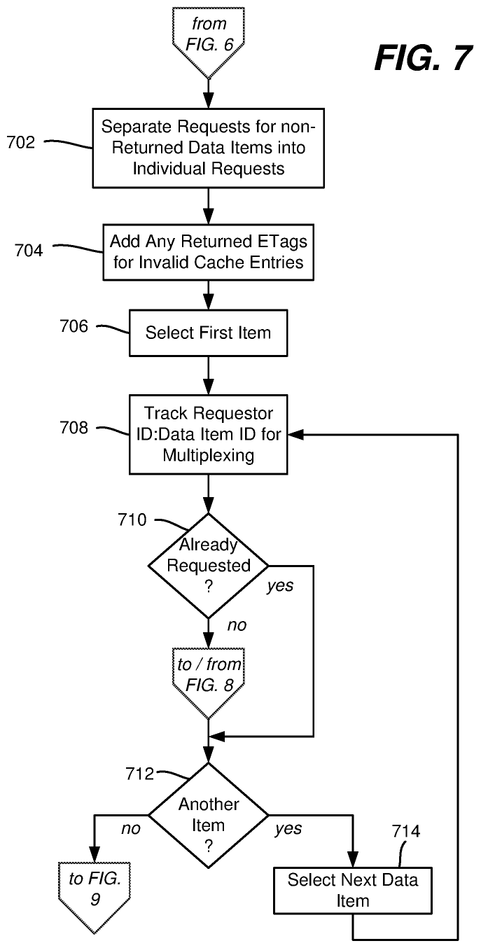

Step 604 represents requesting the data items from the cache framework. Note that this is possible because the cache framework in one or more implementations is able to handle batch requests; if not able to do so, it is understood that the cache set can be individually accessed with each data item key, e.g., after separating the batch request into individual requests at step 702 of FIG. 7. Further, note that in alternative implementations if multiple caches are present, the caches may be accessed in order, with a response returned for any valid, found item from one cache before (or while) checking a subsequent cache for any remaining item or items; in such an implementation, a faster response is returned for item(s) in an earlier accessed cache. However, for purposes of this example, consider that a single response returns any valid, cached items for a set of two or more caches, (which also is what happens if there is only one cache).

Step 606 evaluates whether at least one requested item was returned from the cache in a valid (non-expired) state. If so, these items are returned via steps 608 and 610 in a partial or full batch response to the batch request to the front end server; note that this batch response may be demultiplexed as needed at the front-end.

Step 612 evaluates whether the data item retrieval process is done for this request, that is, all requested items were returned from a cache. If so, the process ends, otherwise the process continues to the steps of FIG. 7 to retrieve any remaining data item or data items.

FIG. 7 step 702 represents separating the remaining batched item or items into individual data item requests. Step 704 adds any ETag data to each request if it exists; note that the ETag value may have come from a front end cache or a back end cache. Step 706 selects the first (possibly only) remaining data item.

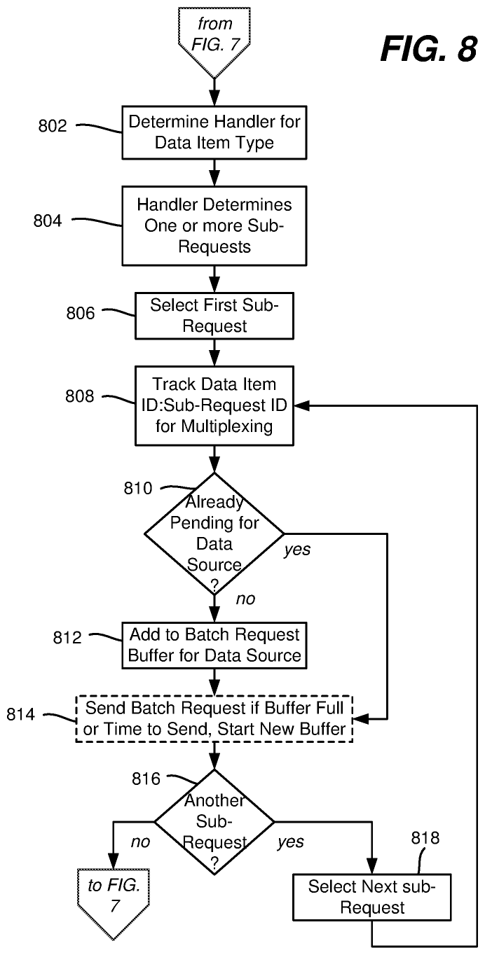

Step 708 represents a multiplexing tracking operation that records the requestor in conjunction with the requested data item. In this way, when the data item is returned, multiple requestors can get back the data item even if only a single request is made for that data item. Step 710 evaluates whether the data item is already in a pending request, e.g., from another requestor (or another instance of the same requestor); if not, the process continues to FIG. 8 to get the data item, otherwise the same response can be used for each request for that same data item. Steps 712 and 714 repeat the process for each other remaining data item (if any) until none remain.

FIG. 8 represents obtaining the data for a requested data item, including step 802 which determines the handler for the data type of the data item, and step 804 where the handler determines the needed subpart or subparts for that data item. Step 806 selects the first data item subpart.

Step 808 tracks the data item to data item subpart relationship if subpart multiplexing is taking place. That is, two or more different data items may each need the same subpart, yet via multiplexing only one request need be made to the data source. Step 810 evaluates whether the item subpart request is already pending, e.g., is in a batch buffer ready to be sent (if batching to each data source is occurring), or has already been sent. If not, step 812 adds the request for the subpart to the batch buffer (or sends the request right away if not batching).

Step 814 represents sending the batch buffer to the request, e.g., one batch buffer (or more) to each data source per timeframe, and then starting a new buffer. Note that step 814 is shown as a dashed block, because sending the buffer or buffers is generally a separate process, e.g., the steps of FIG. 8 load the current batch buffer with the request(s) for each backing data source, while a separate process sends the buffer when full or at a time limit, and starts a new buffer.

Steps 816 and 818 repeat the process for each other sub-request. When none remain, the process returns to FIG. 7, step 712 to request the subpart(s) of the next data item (if any).

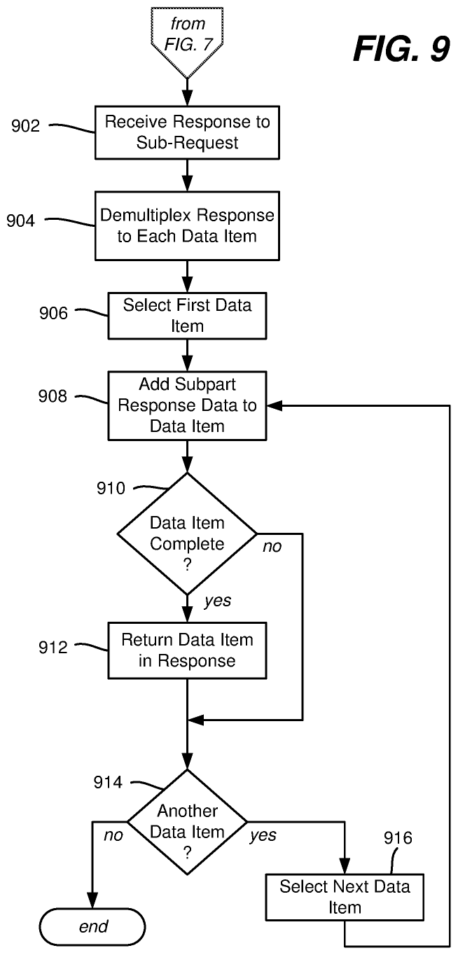

FIG. 9 represents handling the subpart response when one is received, beginning at step 902. Step 904 demultiplexes the subpart response by locating each data item instance that is tracked with respect to this subpart.

Step 906 selects the first data item, and adds the subpart response data to that data item. If the data item is complete, then it is returned as a response, e.g., to the multiplexer that requested the data item at steps (708 and 710) for demultiplexing into one or more responses to each of the one or more front end data servers that had requested the data item. The cache framework also obtains the response for caching at the back end data service cache(s). To reiterate, to avoid possible delays due to multiplexing, the response containing the data item is not put into a batch response at this back-end to front-end data service level in one or more implementations, although it may be part of a partial batch response with any other data items that are ready at generally the same time.

As described above, the subpart response may be demultiplexed to more than one data item. If so, steps 914 and 916 repeat the adding of the subpart response data to each other data item that is impacted.

Note that it is possible to use ETags to avoid data responses for subparts when that data has not changed, although this necessitates an ETag for each piece of a data item that wants to use an ETag. An ETag also may be used to avoid sending a data item to the front end server when its data is retrieved from the one or more backing data sources and its ETag computed at the back end server indicates the data is unchanged with respect to a the front end's ETag value. Instead, the response may indicate that the data is unchanged, and provide an updated cache TTL value as appropriate.

Further, many data items are made up of a single “subpart” maintained at a backing data store, whereby the ETag from an expired cached data item remains useable throughout the data service, including for requests to the backing data sources. Thus, unchanged data need not be included in at least some responses to the back end servers from the backing data sources, or in responses with data known to be unchanged from the back end servers to the front end servers or from front end servers to clients. In a large scale data service capable of handling on the order of millions of generally simultaneous client requests, a significant amount of data communication may be avoided.

As can be seen, described herein is a technology that provides responses to requests for data in a normalized and unified node format, regardless of how the underlying data is actually maintained. The underlying data that supports a node may be maintained in different formats and/or maintained in different data sources, with each requested data item retrieved in one or more subparts and processed according to the node's data type into node data as expected by a client. Caching, along with batching and multiplexing of the data items at any of possible multiple data retrieval levels facilitate efficient data responses in large scale data services while conserving considerable computing and network resources. The use of ETags similarly conserves computing and network resources.

One or more aspects are directed towards receiving a request for a data item having a data type and graph node format and determining a handler for the data type. Aspects include using information in the handler for retrieving data for the data item from one or more backing data sources, processing the data into the graph node format, creating one or more links between a node in the graph node format and one or more other nodes, and returning the data item in response to the request. Creating the one or more links between the node in the graph node format and the one or more other nodes may form a graph node structure.

Receiving the request for the data item may comprise receiving a Uniform Resource Name (URN) as an identifier of the data item, and further comprising, determining the data type of the data item from the URN.

Using the information in the handler for retrieving the data for the data item may comprise determining which one or ones of the one or more backing data sources contain the data for the data item. Using the information in the handler for retrieving the data for the data item may comprise using an API call over hypertext transfer protocol, using a database access protocol or reading from a file, or any combination of using an API call over hypertext transfer protocol, using a database access protocol or reading from a file. Using the information in the handler to retrieve data for the data item may comprise determining that a plurality of backing data sources contain the data for the data item in subparts; if so, described herein is requesting a first subpart of data for the data item from one backing data source, requesting a second subpart of data for the data item from another backing data source, and assembling the data item data from a first sub-response containing data corresponding to the first subpart request and a second sub-response containing data corresponding to the second subpart request.

Also described herein is multiplexing two requests for a same data item subpart into a single request for the data item subpart, and demultiplexing a single response to the single subpart request into two subpart responses, each response corresponding to one of the two requests. Two or more data item subpart requests may be batched into a batched request.

Receiving the request for a data item may include receiving an ETag value associated with the request, the ETag value representing a set of existing data. The ETag value may be sent with a request to a data source for a set of requested data, with an indication based upon the ETag value received that indicates that the requested set of data has not changed relative to the set of existing data; a response may be returned that indicates that the set of existing data is valid for use.

The request for the data item may be received as part of a batch request for a plurality of data items. The data item may be returned in a response to the request that is not part of a batch request or in a response that is part of a partial batch request that contains responses for less than all data items requested in the batch request.

The receiving of the request for a data item may occur at a back end data server that is coupled to a front end data server that sent the request; if so, described is caching the data item in a cache coupled to the back end data server.

One or more aspects are directed towards a data service having front end data servers coupled to clients and a back end data service having back end data servers coupled to the front end data servers, in which a client makes a request for a data item to a front end server, and the front end server makes a corresponding request for the data item from the front end server to a back end server. Described herein is a cache set coupled to the back end server, with the back end server configured to access the cache set for a valid copy of the data item. If a valid copy is found, the back end server returns information corresponding to the data item to the front end server in response to the request. If a valid copy is not found, the back end server makes one or more requests for data of the data item to one or more backing data sources, processes data in one or more backing data source responses to the one more requests into a single response, and returns the single response to the front end server in response to the request from the front end server.

If a valid copy is found, the information corresponding to the data item returned to the front end server may contain information indicating that existing data corresponding to the data item is unchanged. If a valid copy is found, the information corresponding to the data item returned to the front end server may contain data of the requested data item.

If a valid copy is not found, the single response returned to the front end server may contain information indicating that existing data corresponding to the data item is unchanged. If a valid copy is not found, the single response returned to the front end server may contain data of the requested data item.

If a valid copy is not found, and the back end server may locate a handler corresponding to a type of the data item, and use the handler to determine which one or ones of the one or more backing data sources contain data for the data item, and to request data for the data item from each of the one or more backing data sources containing data for the data item. The handler located at the back end server may determine that the data item data is maintained as a plurality of subparts; if so, the back end server requests each subpart in a corresponding plurality of requests.

One or more aspects are directed towards receiving a request for an identified graph node containing a dataset and separating the request into a plurality of sub-requests, each request corresponding to a subpart of the dataset. The plurality of sub-requests is made to one or more backing data sources. A plurality of responses is received, each response corresponding to a sub-request and containing a requested subpart of the dataset. Described herein is assembling each requested subpart into the graph node dataset.

The graph node identified in the request may have a determined data type, with a handler corresponding to that data type selected and used for separating the request into a plurality of sub-requests. The handler may be used for processing each subpart into the graph node dataset.

### Example Computing Device

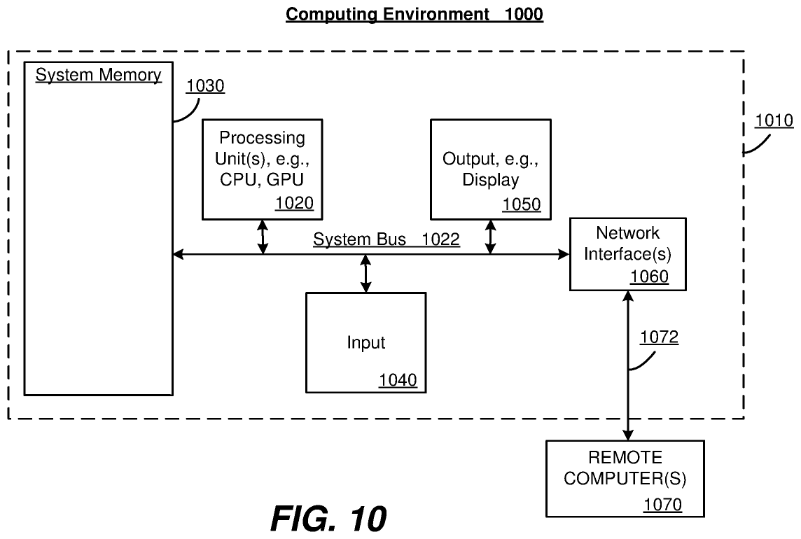

The techniques described herein can be applied to any device or set of devices (machines) capable of running programs and processes. It can be understood, therefore, that personal computers, laptops, handheld, portable and other computing devices and computing objects of all kinds including cell phones, tablet/slate computers, gaming/entertainment consoles and the like are contemplated for use in connection with various implementations including those exemplified herein. Servers including physical and/or virtual machines are likewise suitable computing machines/devices. Accordingly, the general purpose computing mechanism described below in FIG. 10 is but one example of a computing device.

Implementations can partly be implemented via an operating system, for use by a developer of services for a device or object, and/or included within application software that operates to perform one or more functional aspects of the various implementations described herein. Software may be described in the general context of computer executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol is considered limiting.

FIG. 10 thus illustrates an example of a suitable computing system environment 1000 in which one or aspects of the implementations described herein can be implemented, although as made clear above, the computing system environment 1000 is only one example of a suitable computing environment and is not intended to suggest any limitation as to scope of use or functionality. In addition, the computing system environment 1000 is not intended to be interpreted as having any dependency relating to any one or combination of components illustrated in the example computing system environment 1000.

With reference to FIG. 10, an example device for implementing one or more implementations includes a general purpose computing device in the form of a computer 1010. Components of computer 1010 may include, but are not limited to, a processing unit 1020, a system memory 1030, and a system bus 1022 that couples various system components including the system memory to the processing unit 1020.

Computer 1010 typically includes a variety of machine (e.g., computer) readable media and can be any available media that can be accessed by a machine such as the computer 1010. The system memory 1030 may include computer storage media in the form of volatile and/or nonvolatile memory such as read only memory (ROM) and/or random access memory (RAM), and hard drive media, optical storage media, flash media, and so forth. By way of example, and not limitation, system memory 1030 may also include an operating system, application programs, other program modules, and program data.

A user can enter commands and information into the computer 1010 through one or more input devices 1040. A monitor or other type of display device is also connected to the system bus 1022 via an interface, such as output interface 1050. In addition to a monitor, computers can also include other peripheral output devices such as speakers and a printer, which may be connected through output interface 1050.

The computer 1010 may operate in a networked or distributed environment using logical connections to one or more other remote computers, such as remote computer 1070. The remote computer 1070 may be a personal computer, a server, a router, a network PC, a peer device or other common network node, or any other remote media consumption or transmission device, and may include any or all of the elements described above relative to the computer 1010. The logical connections depicted in FIG. 10 include a network 1072, such as a local area network (LAN) or a wide area network (WAN), but may also include other networks/buses. Such networking environments are commonplace in homes, offices, enterprise-wide computer networks, intranets and the internet.

As mentioned above, while example implementations have been described in connection with various computing devices and network architectures, the underlying concepts may be applied to any network system and any computing device or system in which it is desirable to implement such technology.

Also, there are multiple ways to implement the same or similar functionality, e.g., an appropriate API, tool kit, driver code, operating system, control, standalone or downloadable software object, etc., which enables applications and services to take advantage of the techniques provided herein. Thus, implementations herein are contemplated from the standpoint of an API (or other software object), as well as from a software or hardware object that implements one or more implementations as described herein. Thus, various implementations described herein can have aspects that are wholly in hardware, partly in hardware and partly in software, as well as wholly in software.

The word “example” is used herein to mean serving as an example, instance, or illustration. For the avoidance of doubt, the subject matter disclosed herein is not limited by such examples. In addition, any aspect or design described herein as “example” is not necessarily to be construed as preferred or advantageous over other aspects or designs, nor is it meant to preclude equivalent example structures and techniques known to those of ordinary skill in the art. Furthermore, to the extent that the terms “includes,” “has,” “contains,” and other similar words are used, for the avoidance of doubt, such terms are intended to be inclusive in a manner similar to the term “comprising” as an open transition word without precluding any additional or other elements when employed in a claim.

As mentioned, the various techniques described herein may be implemented in connection with hardware or software or, where appropriate, with a combination of both. As used herein, the terms “component,” “module,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it can be noted that one or more components may be combined into a single component providing aggregate functionality or divided into several separate sub-components, and that any one or more middle layers, such as a management layer, may be provided to communicatively couple to such sub-components in order to provide integrated functionality. Any components described herein may also interact with one or more other components not specifically described herein but generally known by those of skill in the art.

In view of the example systems described herein, methodologies that may be implemented in accordance with the described subject matter can also be appreciated with reference to the flowcharts/flow diagrams of the various figures. While for purposes of simplicity of explanation, the methodologies are shown and described as a series of blocks, it is to be understood and appreciated that the various implementations are not limited by the order of the blocks, as some blocks may occur in different orders and/or concurrently with other blocks from what is depicted and described herein. Where non-sequential, or branched, flow is illustrated via flowcharts/flow diagrams, it can be appreciated that various other branches, flow paths, and orders of the blocks, may be implemented which achieve the same or a similar result. Moreover, some illustrated blocks are optional in implementing the methodologies described herein.

### CONCLUSION

While the invention is susceptible to various modifications and alternative constructions, certain illustrated implementations thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

In addition to the various implementations described herein, it is to be understood that other similar implementations can be used or modifications and additions can be made to the described implementation(s) for performing the same or equivalent function of the corresponding implementation(s) without deviating therefrom. Still further, multiple processing chips or multiple devices can share the performance of one or more functions described herein, and similarly, storage can be effected across a plurality of devices. Accordingly, the invention is not to be limited to any single implementation, but rather is to be construed in breadth, spirit and scope in accordance with the appended claims.

What is claimed is:

1. A system, comprising:
a processor; and
a memory that sources executable instructions which, when executed by the processor of the system, facilitate performance of operations, the operations comprising:
receiving a request for a data item having an identifier and associated type information;
selecting a selected handler from among a group of handlers based on the type information;
obtaining, via the selected handler and based on the identifier, a first set of data corresponding to a first part of the data item from one or more first data sources, and a second set of data corresponding to a second part of the data item from one or more second data sources;
processing the first set of data and the second set of data into a graph node data structure; and
caching the graph node data structure.

2. The system of claim 1, wherein the caching the graph node data structure comprises caching the graph node data structure at a front end data service cache.

3. The system of claim 1, wherein the obtaining the first set of data comprises obtaining a first property subpart comprising first property data from a first data store and obtaining a second property subpart comprising second property data from a second data store.

4. The system of claim 1, wherein the obtaining the second set of data comprises obtaining a reference set.

5. The system of claim 4, wherein the reference set comprises an edge to another graph node data structure.

6. The system of claim 1, wherein the processing the first set of data and the second set of data into the graph node data structure comprises reassembling the first set of data and the second set of data into a dataset.

7. The system of claim 6, wherein the processing further comprises formatting at least part of the dataset for a specified client device type and software version into the graph node data structure.

8. The system of claim 1, wherein the handler determines the first part of the data item and determines a data source mapping data to the one or more first data sources.

9. The system of claim 1, wherein the handler provides access credentials to at least one of the one or more first data sources.

10. The system of claim 1, wherein the caching the graph node data structure comprises caching the graph node data structure at a front end data service cache.

11. The system of claim 10, wherein the operations further comprise, receiving a client request for the data item, and returning the graph node data structure from the front end data service cache in response to the client request.

12. The system of claim 1, wherein receiving the request for the data item comprises receiving a Uniform Resource Name (URN) as an identifier of the data item, and wherein the operations further comprise, determining the associated type information from the URN.

13. A method, comprising:
receiving a first request for a first data item having a first identifier with first associated type information;
receiving a second request for a second data item having a second identifier with second associated type information that is different from the first type information;
selecting a first selected handler from among a group of handlers based on the first type information;
selecting a second selected handler from among the group of handlers based on the second type information, wherein the second selected handler is different from the first selected handler;
obtaining, via the first selected handler and based on the first identifier, a first dataset; and
obtaining, via the second selected handler and based on the second identifier, a second dataset.

14. The method of claim 13, further comprising processing, including by the first selected handler, the first dataset into a first graph node data structure and caching the first graph node data structure, and processing, including by the second selected handler, the second dataset into a second graph node data structure and caching the second graph node data structure

15. The method of claim 13, wherein the first data item comprises a first subpart and a second subpart, and wherein the obtaining, via the first selected handler the first dataset comprises accessing one data source to obtain the first subpart and accessing another, different data source to obtain the second subpart.

16. The method of claim 13, wherein receiving the first request for the first data item comprises receiving a Uniform Resource Name (URN) as an identifier of the first data item, and further comprising determining the first associated type information from the URN.

17. One or more machine-readable storage media having machine-executable instructions, which when executed perform operations, the operations comprising:
receiving a request for a data item having an identifier;
determining type information associated with the data item from the identifier;
selecting a selected handler from among a group of handlers based on the type information;
obtaining, via the selected handler and based on the identifier, a first set of data corresponding to a first part of the data item from one or more first data sources, and a second set of data corresponding to a second part of the data item from one or more second data sources; and
processing the first set of data and the second set of data into a graph node data structure.

18. The one or more machine-readable storage media of claim 17, wherein the operations further comprise, caching the graph node data structure in a cache coupled to a client-interfacing data service, receiving a client request for the data item at the client-interfacing data service, and returning the graph node data structure in response to the client request.

19. The one or more machine-readable storage media of claim 17, wherein the obtaining the first set of data from the one or more first data sources comprises obtaining property data, and wherein the obtaining the second set of data from the one or more second data sources comprises obtaining reference data.

20. The one or more machine-readable storage media of claim 17, wherein the receiving the request for the first data item comprises receiving a Uniform Resource Name (URN) as an identifier, and wherein the operations further comprise determining the type information from the URN.
